(19) United States
(12) Patent Application Publication
(10) Pub. No.: US 2026/0148157 A1
(43) Pub. Date: May 28, 2026

(54) MANAGED MACHINE LEARNING RESOURCE SHARING

(71) Applicant: Amazon Technologies, Inc., Seattle, WA (US)

(72) Inventors: Bharath Lakshman, Mountain View, CA (US); Arun Babu Nagarajan, Redmond, WA (US); Arvind Sowmyan, Seattle, WA (US); Kareemuddin Syed-Mohammed, Sammamish, WA (US)

(73) Assignee: Amazon Technologies, Inc., Seattle, WA (US)

(21) Appl. No.: 18/962,688

(22) Filed: Nov. 27, 2024

(51) Int. Cl. G06Q 10/0631; G06F 9/54

(52) U.S. Cl. CPC G06Q 10/06313; G06F 9/54

(57) ABSTRACT

A machine learning resource management service allows customers to define machine learning projects and machine learning resource allocations for the machine learning projects, such that different levels of resources are allocated to different ones of the projects. Additionally, the machine learning resource management service enables burst capacity at respective ones of the machine learning projects using under-utilized resources of other ones of the machine learning resources, while ensuring the customer defined resource allocations for the different machine learning projects are enforced. Additionally, the machine learning resource management service may track usage of burst capacity among the projects to ensure fair sharing of burst capacity.

### BACKGROUND

Large-scale machine learning models are being developed and deployed for a variety of applications. For example, generative artificial intelligence (GAI) models such as large language models (LLMs) with millions or even billions of parameters are trained to conduct intelligent searches, participate in multi-turn conversations, and so on. The training of such models can take large amount of input data, numerous machines and long periods of time. Also, specialized hardware resources, such as graphics processing units (GPUs) or other machine learning hardware accelerators may be used to train such machine learning models. However, usage of the hardware resources may vary during different phases of training, such that some hardware resources allocated to a machine learning project may go un-used for at least some portion of time. Also, training being performed for other machine learning projects may be resource constrained for at least some portion of time. Such in-balances between projects may lead to inefficient usage of underlying hardware resources, and/or may result in slower training times than would be achievable without the hardware constraints.

### BRIEF DESCRIPTION OF DRAWINGS

FIG. 1 illustrates an example system environment comprising different machine learning resource services and a machine learning resource management service, wherein customers of the machine learning resource management service are enabled to define, via an API, machine learning projects and policies, and wherein the machine learning resource management service automatically generates configuration instructions that are sent to the different machine learning resource services via another set of APIs to cause the machine learning resource services to provide configurations for the customer defined projects that conform to the customer defined policies for those projects, according to some embodiments.

FIG. 2 illustrates additional components that may be included in the project policy manager and the project resource scheduler of the machine learning resource management service, according to some embodiments.

FIG. 3 is a flow diagram illustrating a process for implementing machine learning resource management for projects of a customer in a way that allows sharing of resources across projects to increase efficient use of customer allocated resources, according to some embodiments.

FIG. 4 illustrates a first example configuration of a machine learning resource management system, wherein customer users (e.g. data scientists) submit machine learning tasks directly to the machine learning resources allocated to the respective projects of the customer, and the machine learning resource management system adjusts the resource allocations to the respective projects to allow under-utilized resources to be used by other projects of the customer, according to some embodiments.

FIG. 5 illustrates a second example configuration of a machine learning resource management system, wherein customer users (e.g. data scientists) submit machine learning tasks for projects of the customer to a machine learning resource management system, and the machine learning resource management system forwards the tasks on to the machine learning resources allocated to the projects that are to perform the tasks, wherein the machine learning resource management system adjusts resource allocations to the projects to allow under-utilized resources to be used by other projects of the customer, according to some embodiments.

FIG. 6 illustrates a third example configuration of a machine learning resource management system, wherein customer users (e.g. data scientists) submit machine learning tasks directly to the machine learning resources allocated to the respective projects of the customer, the machine learning resources coordinate with a third-party machine learning task scheduler to schedule execution of the tasks using resources allocated to the projects of the customer, and the machine learning resource management system adjusts the resource allocations for the respective projects to allow under-utilized resources to be used by other projects of the customer, according to some embodiments.

FIG. 7 illustrates example projects and associated policies that may be stored in a project policy information store of a policy manager for a machine learning resource management system, according to some embodiments.

FIG. 8A illustrates observability information for resources allocated to projects of a customer being collected by a project resource scheduler of the machine learning resource management service, according to some embodiments.

FIG. 8B illustrates updated configuration instructions being sent to the resource services that provide the resources allocated to the projects of the customer to adjust the resource allocations, wherein a resource initially allocated to a first project of the customer (that is currently under-utilized) is temporarily re-allocated to a second project of the customer to provide burst capacity to the second project for a limited amount of time (or until pre-empted by the first project), according to some embodiments.

FIG. 9 illustrates examples of usage metadata that may be included in management metadata used by a project resource scheduler to ensure fair share resource allocation and bursting, according to some embodiments.

FIGS. 10A-10B illustrate a snapshot being taken of a first project that is using burst capacity to speed-up training of a machine learning model, wherein the burst capacity provided to the first project is subsequently pre-empted by a second project, and further wherein an under-utilized resource originally allocated to a third project is then re-allocated to the first project to provide additional burst capacity, wherein the snapshot taken prior to pre-emption of the first burst capacity is provided to the resource provided to enable the additional burst capacity such that the resource provided to enable the additional burst capacity can take advantage of training performed by the first resource provided for the first burst capacity, according to some embodiments.

FIG. 11 is a flow diagram illustrating a process of sharing resources across projects to enable burst capacity for a given project, according to some embodiments.

FIG. 12 is a flow diagram illustrating a process of pre-empting, by a first project, access to a resource temporarily loaned from the first project to a second project, in response to a resource utilization level of the first project exceeding a threshold amount, according to some embodiments.

FIG. 13 is a flow diagram illustrating allocating burst capacity based on a fair share resource sharing scheme, according to some embodiments.

FIG. 14 is a flow diagram illustrating an example process of snapshotting projects using burst capacity and using the snapshots to subsequently provided resources to reduce loss of learning due to pre-emption, according to some embodiments.

FIG. 15 illustrates an example provider network at which a machine learning service may be implemented, according to at least some embodiments.

FIG. 16 is a block diagram illustrating an example computing device that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof. Unless otherwise explicitly stated, articles such as “a” or “an” should generally be interpreted to include one or more described items throughout this application. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

### DETAILED DESCRIPTION

The present disclosure relates to efficient sharing of machine learning resources across projects of a customer, wherein under-utilized machine learning resources of a first project are made available for use as “burst capacity” by other projects of the customer. In order to manage such sharing of under-utilized resources as burst capacity, a machine learning resource management system/service tracks usage metrics of all resources allocated to projects of the customer and generates updated configuration instructions to re-allocate resources of the customer between projects. The updated configuration instructions are automatically provided to the underlying services of a service provider network that provide the machine learning resources to the customer. In this way, resource separation and allocation differences between projects of the customer are maintained, but at the same time under-utilized resources of the customer are not wasted due to being siloed into a given project that is currently not using its full allocation of resources.

In some embodiments, the machine learning resource management system/service further implements fair share tracking with regard to allocation of burst capacity. For example, projects that provide burst capacity to other projects are tracked as well as the amounts of burst capacity provided. Likewise, projects that consume burst capacity as well as the amounts of burst capacity consumed are tracked. Based on the amounts of burst capacity previously provided and consumed, the respective projects are prioritized for access to future burst capacity. For example, if there is a limited amount of burst capacity available, projects that are higher ranked will have priority to use the limited amount of available burst capacity ahead of other projects that are lower ranked. Also, in some embodiments, an administrator (e.g. administrative user of the customer) may define prioritization schemes for the projects of the customer. In such embodiments, administrative priorities may also be used in determining which projects are prioritized for access to future burst capacity.

In some embodiments, burst capacity provided to a given project from under-utilized capacity of another project may be pre-empted, in response to utilization at the other project increasing, such that it exceeds a pre-emption threshold. In such a case, the burst capacity provided to the given project may be revoked with, or without, notice and returned to the other project.

In some embodiments, a machine learning resource management system/service causes snapshots to be taken and stored during training of machine learning models by respective ones of the projects managed by the machine learning resource management system/service. For example, periodic snapshots may be taken of a machine learning model being trained by a given set of machine learning resources allocated to a first project. If the first project is using burst capacity, this burst capacity may be pre-empted. However, a snapshot taken prior to the pre-emption may enable the machine learning model training to continue from a progress point corresponding to a most recent snapshot. For example, when capacity becomes available (e.g. either due to receiving additional burst capacity or due to already allocated resources of the project becoming available) the partially completed machine learning training job can be resumed from the snapshot without having to start over from the beginning of the training process.

In some embodiments, a machine learning resource management service may be used to manage allocations of existing machine learning resources for existing projects of a customer that is performed in a way that is transparent to users of the customer, such as data scientists. For example, an administrator of the customer may enroll the customer's allocated resources and projects in the machine learning resource management service, while allowing the data scientists to interact with existing machine learning service interfaces for scheduling jobs and for receiving results of the jobs. However, the data scientists may experience better performance with regard to executing machine learning tasks than was possible prior to the enrollment in the machine learning resource management service. For example, the machine learning resource management service may enable projects of the customer to use under-utilized resources of other projects as “burst capacity”, where this was not previously possible. Thus, the customers'existing machine learning resources may be used more efficiently due to enrollment in the machine learning resource management service. However, from the perspective of the data scientists using the machine learning resources, the process of submitting jobs and tasks as well as receiving results may appear unchanged (thus allowing a transparent migration to using the machine learning resource management system/service from the perspective of the data scientists).

In some embodiments, administrative users of the customer may update or change policies associated with respective projects of the customer and the machine learning resource management service may automatically generate updated configuration instructions to implement the policy changes and provide the updated configuration instructions to a set of application programmatic interfaces (APIs) of the underlying machine learning resource services that provide resources to the projects. These updated configuration instructions may cause changes in how the underling resources are configured, for example by changing numbers, sizes, etc. of nodes included in different resource clusters associated with the respective projects.

In some embodiments, jobs submitted for execution (e.g. by data scientist users of the customer) may be flagged as opting out (or into) burst capacity usage. Thus, some jobs which are to be run to completion (without the possibility of pre-emption) may be flagged as opting-out of using burst capacity.

In some embodiments, the machine learning resource management system/service provides users (e.g. data scientists and/or administrators) with one or more dashboards that enable observability of the machine learning resources being used to perform training tasks. For example, such dashboards may indicate usage metrics for the respective projects as well as expected waiting times for machine learning tasks currently in a queue of tasks to be performed.

In some embodiments, in order to provide burst capacity, instead of moving a resource from a first cluster to a second cluster in order to provide a second project access to an under-utilized resource of a first project, the machine learning resource management system/service may implement a scheduler that re-directs certain tasks submitted for the second project to instead be executed using an under-utilized resource allocated to the first project, such as an under-utilized resource of a first cluster, wherein the second project is associated with a second cluster.

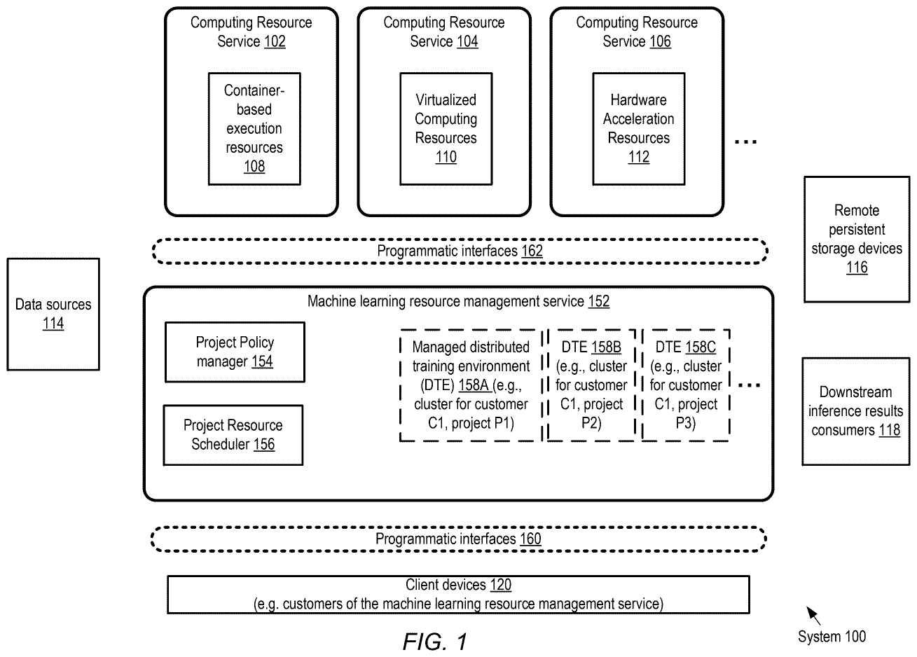

FIG. 1 illustrates an example system environment comprising different machine learning resource services and a machine learning resource management service, wherein customers of the machine learning resource management service are enabled to define, via an API, machine learning projects and policies, and wherein the machine learning resource management service automatically generates configuration instructions that are sent to the different machine learning resource services via another set of APIs to cause the machine learning resource services to provide configurations for the customer defined projects that conform to the customer defined policies for those projects, according to some embodiments.

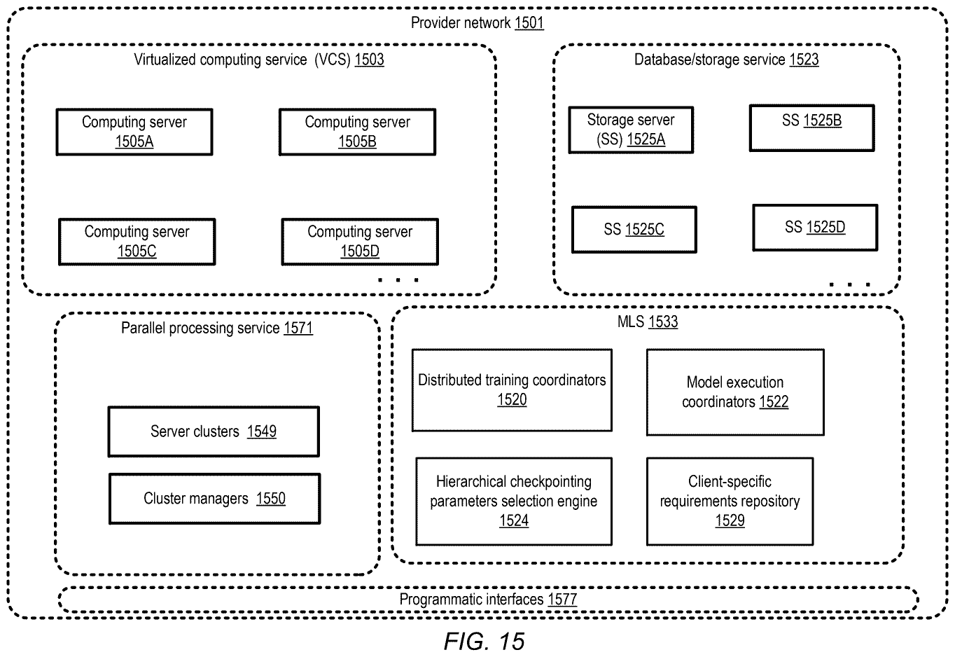

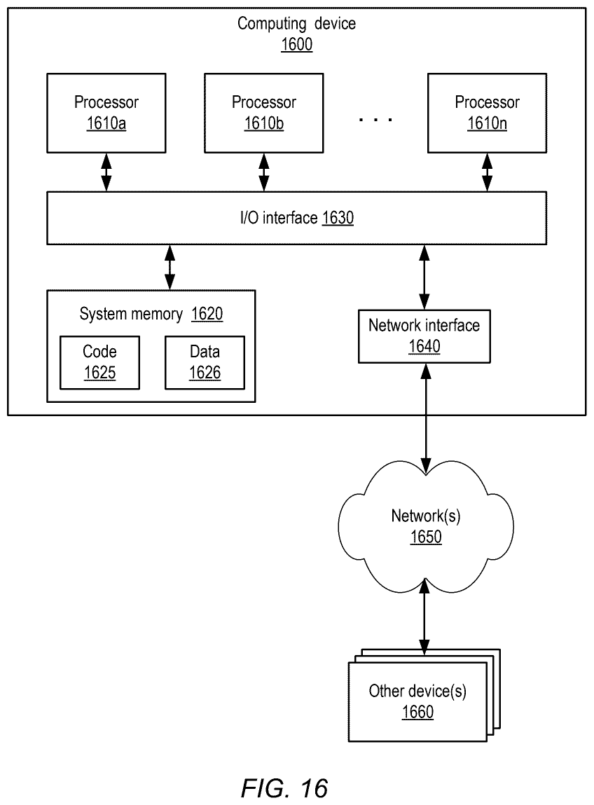

System 100 includes various computing resource services, such as may be included in a cloud-service provider network, as well as a machine learning management service. For example, system 100 includes computing resource services 102, 104, and 106, as well as machine learning resource management service 152. In some embodiments, the computing resource services may be any of the computing resource services further described in FIG. 15 that are included in service provider network 1501 (or other cloud-based resource services), and may be implemented using underlying computing devices, such as computing device 1600 shown in FIG. 16. As a few examples, computing resource service 102 provides container-based execution resources 108, computing resource service 104 provides virtualized computing resources 110, and computing resource service 106 provides hardware acceleration resources 112 (such as GPU access). In some embodiments, various combinations of such resources of the various computing resource service providers 102, 104, and 106 may be used together in a managed distributed training environment (DTE), such as a cluster of nodes assigned to a project. As a few examples, a first customer may have three projects and separate DTE's (e.g. clusters) may be configured for each of the customer's projects, such as DTE 158A, DTE 158B, and DTE 158C. Note that for simplicity of illustration, FIG. 1 discusses projects of a single customer (C1). However, in some embodiments, machine learning resource management service 152 may manage multiple sets of projects for multiple customers concurrently.

In some embodiments, client devices 120, such as those of an administrative user of machine learning resource management service 152, may interact with the service via application programmatic interfaces 160. For example, to define projects and to assign resource management policies to the respective projects defined for the customer. Additionally, machine learning resource management service 152 may generate initial and updated configuration instructions for configuring the resources of the computing resource services 102, 104, and 106 into the respective distributed training environments 158A, 158B, and 158C, and may submit the initial or updated configuration instructions to the respective computing resource services 102, 104, and 106 via the set of APIs 162.

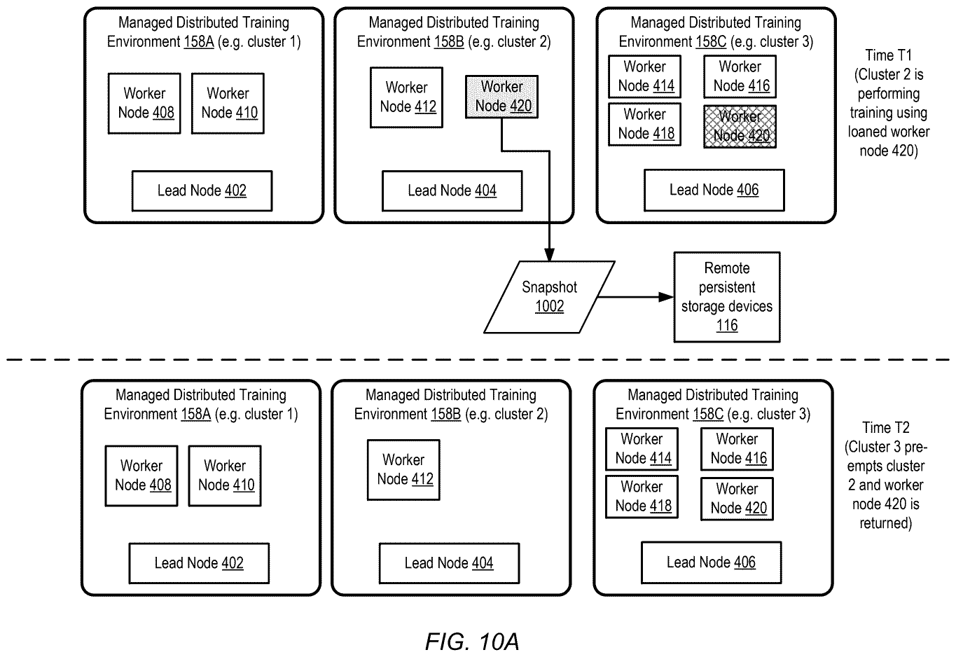

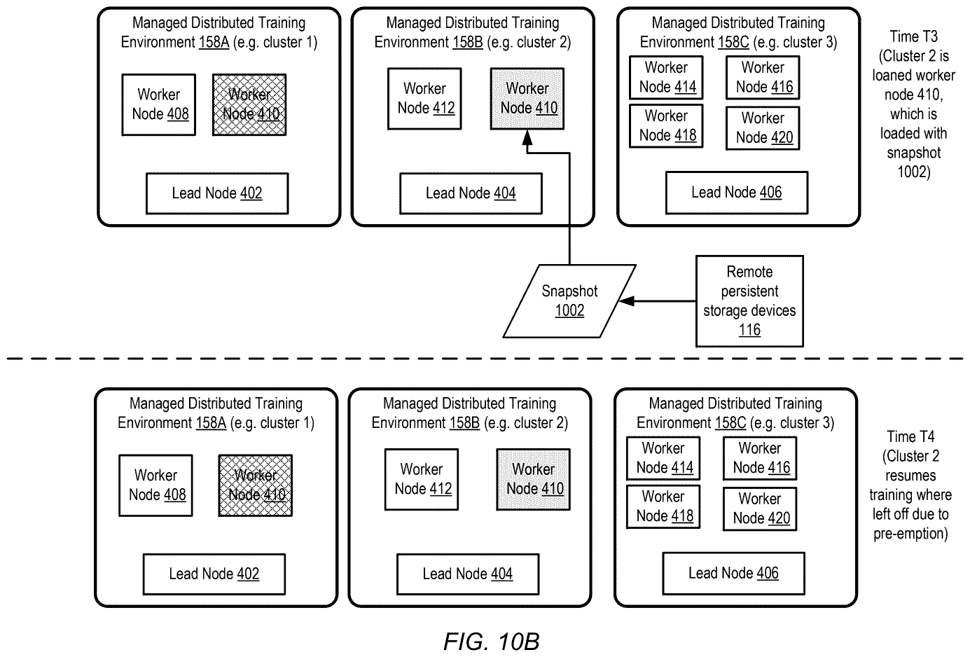

In some embodiments, system 100 may further include data sources 114, such as for storing training data used by machine learning jobs executing in the respective distributed training environments 158A, 158B, and 158C. Also, downstream inference consumers 118 may interact with the trained models implemented using distributed training environments 158A, 158B, and 158C. Also, in some embodiments, as further discussed in FIGS. 10A-10B, snapshots may be taken of respective worker nodes during training and may be stored in a remote persistent storage devices 116, such as may be provided by a storage service of a service provider network.

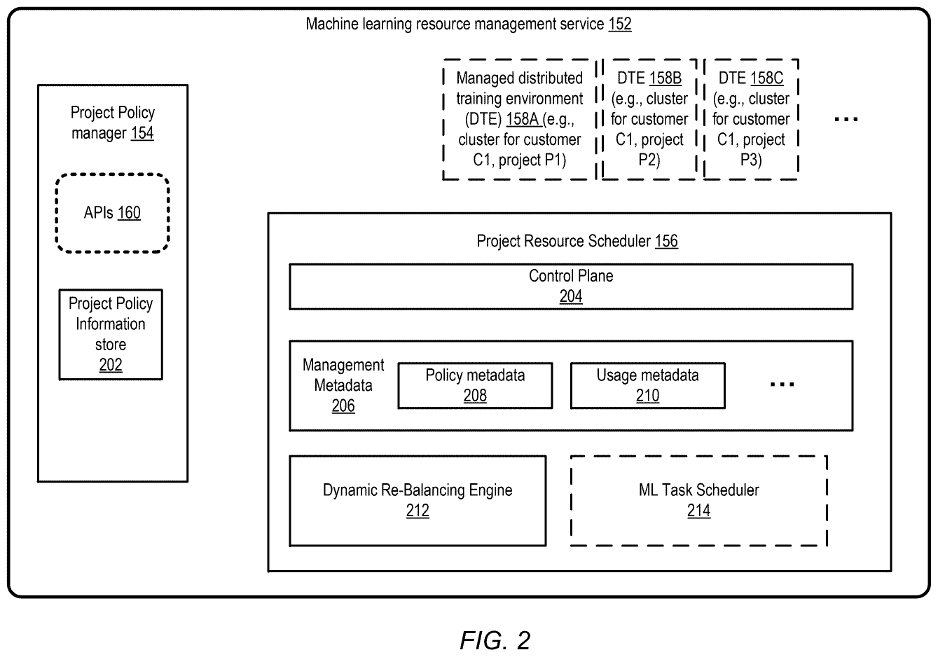

Machine learning resource management service 152 further includes project policy manager 154 and project resource scheduler 156, which are shown in more detail in FIG. 2.

FIG. 2 illustrates additional components that may be included in the project policy manager and the project resource scheduler of the machine learning resource management service, according to some embodiments.

In some embodiments, project policy manager 154 provides APIs 160 that are accessible to administrative users of a customer of the machine learning resource management service 152. For example, an administrative user of the customer may use APIs 160 to define projects and policies associated with the projects of the customer. For example, a project may be defined for a particular data science goal and team members may be assigned to the project via API 160. Additionally, a resource management policy for the project may be defined via API 160. For example, a resource management policy may define an amount of GPU capacity that is to be provided to the project to execute project jobs or tasks. In some embodiments, a policy may define a GPU-hour resource usage limit for a project, such as a total amount of time GPUs may be used to perform work for the project. Also, the policy may define a GPU usage rate allowed for the project, such as an amount of GPU capacity that is allowed to be used per unit of time, such as GPU calculations per second, minute, etc. Also, the policy may indicate whether the resources allocated to the project associated with the policy are available to be used as burst capacity for other projects of the customer, such as with regard to under-utilized resources of the project. Likewise, the policy may indicate whether the associated project is authorized to use “burst capacity” by accessing under-utilized resource capacity of other projects. In some embodiments, burst limits may be defined in the policy, such as a limit on an amount of burst capacity that may be consumed by the associated project and/or a limit on an amount of under-utilized resource capacity of the project that may be used by other projects as “burst capacity.” Additionally, the policy may indicate whether the associated project opts into fair share resource tracking for prioritization of access to “burst capacity.” Also, in some embodiments, the administrative user of the customer may provide a priority indicator for the project, which may be included in its associated policy, such as a high, medium, or low priority. In some embodiments, access to available “burst capacity” may also be determined based on respective priorities associated with the respective projects attempting to acquire “burst capacity.”

In some embodiments, project resource scheduler 156 of machine learning resource management service 152 includes a control plane 204, management metadata 206, a dynamic re-balancing engine 212, and may also optionally include a ML (machine learning) task scheduler 214. In some embodiments, management metadata 206 includes policy metadata 208 and usage metadata 210.

For example, control plane 204 may acquire and update policy metadata 208 based on project information stored in project policy information store 202. Also, control plane 204 may query (or otherwise obtain) metric usage information from the distributed training environments 158A, 158B, and 158C. The acquired metric usage information may be stored as usage metadata 210.

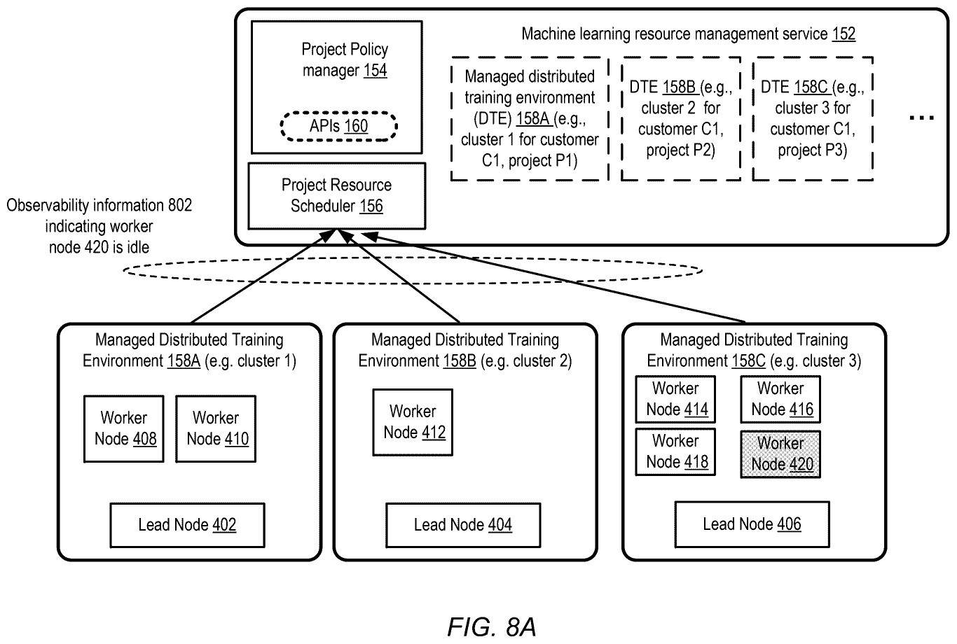

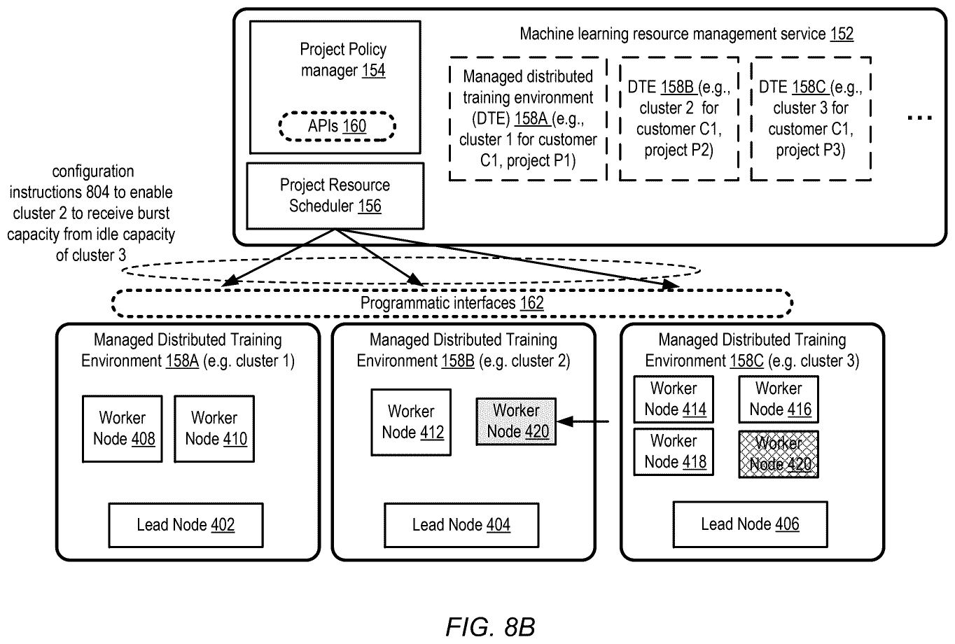

In some embodiments, dynamic re-balancing engine 212 generates updated configuration instructions (e.g. that are provided to computing resource services 102, 104, and/or 106 via APIs 162) based on the policy metadata 208 and usage metadata 210. For example, the dynamic re-balancing engine may move an under-utilized worker node from a first cluster associated with a first project to instead being associated with a second cluster associated with a second project, as shown in FIGS. 8A-8B. This may be performed in response to usage metadata 210 indicating that the first project associated with the first cluster is under-utilizing its resources and in response to the usage metadata 210 indicating that a level of utilization at the second project associated with the second cluster has reached or exceeded a burst threshold. For example, when remaining spare capacity of a given cluster is greater than a threshold amount of spare capacity remaining and there is additional work to be done at the cluster, the cluster may qualify for burst capacity. Or said another way, the project associated with the cluster may be eligible to receive burst capacity.

In some embodiments, additionally, or alternatively, project resource scheduler 156 may include ML task scheduler 214. In some embodiments, instead of moving an under-utilized resource between clusters in order to provide burst capacity, an ML task scheduler 214 may re-direct at least some jobs or tasks submitted to a first cluster to instead be executed using a machine learning resource of another cluster. For example, a job submitted to a highly utilized cluster may be scheduled to instead be executed on a resource of an under-utilized cluster, wherein subsequent to execution at the under-utilized cluster, the results of the execution of the job are provided back to the cluster to which the job was submitted. The cluster that received the job submission may then return the results in a transparent manner, such that from the perspective of the data scientist that submitted the job, it appears as though the job was executed at the cluster to which it was submitted.

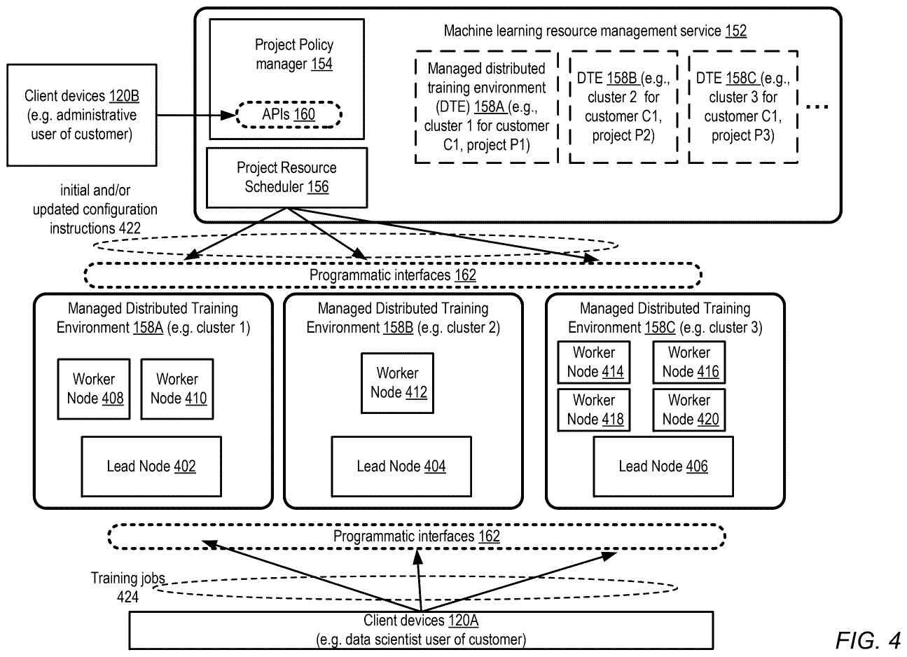

In some embodiments, machine learning resources of multiple projects of a customer may be more efficiently managed using a dynamic re-balancing approach (e.g. via dynamic re-balancing engine 212), may be more efficiently managed using a cross-project task scheduler scheme (e.g. via ML task scheduler 214), or both using dynamic re-balancing and cross-project task scheduling. For example, various example configurations that use re-balancing and/or cross project task scheduling are shown in FIGS. 4-6.

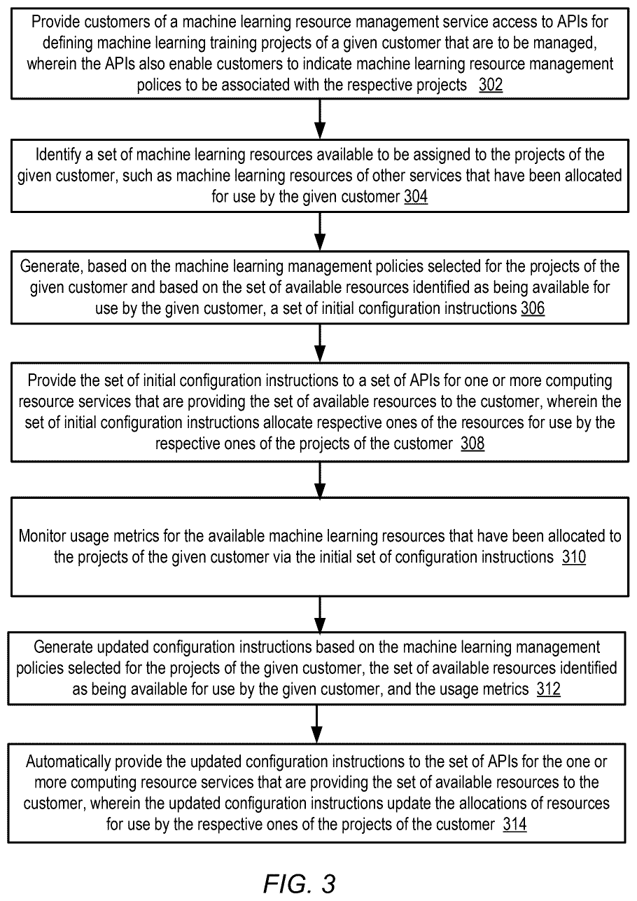

FIG. 3 is a flow diagram illustrating a process for implementing machine learning resource management for projects of a customer in a way that allows sharing of resources across projects to increase efficient use of customer allocated resources, according to some embodiments.

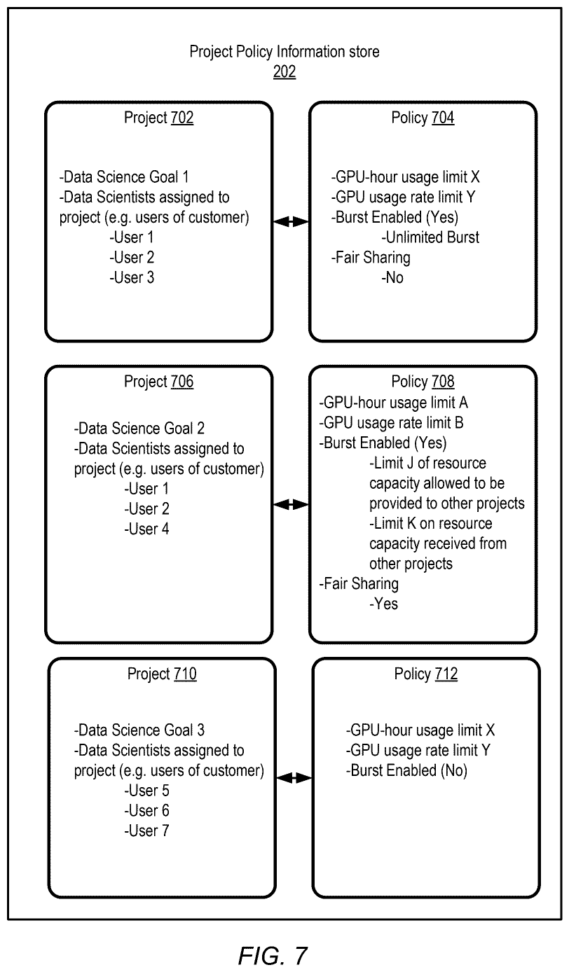

At block 302, a project policy manager of a machine learning resource management system/service, provides customers of the machine learning resource management service access to APIs for defining machine learning training projects that are to be managed by the machine learning resource management system/service. Also, the APIs of the project policy manger of the machine learning resource management system/service enable customers to indicate machine learning resource management polices to be associated with the respective projects. For example, FIG. 7 illustrates example polices associated with example projects. These projects and policies may have been defined by an administrative user of a customer using APIs of the project policy manager, such as APIs 160 of project policy manger 154.

At block 304, the project policy manager of the machine learning resource management system/service, identifies a set of machine learning resources available to be assigned to the projects of the given customer, such as machine learning resources of other services that have been allocated for use by the given customer. For example, the control plane 204 of the project resource scheduler 156 may query computing resource services 102, 104, 106, etc. to identify resources allocated to the customer that are available to be used for machine learning projects of the customer that are to be managed via machine learning resource management service 152.

At block 306, a project resource scheduler of the machine learning resource management service generates an initial set of configuration instructions for configuring resources for one or more projects. For example, each project may have an associated resource cluster (e.g. distributed training environment) and the initial set of configuration instructions may instruct computing resource services 102, 104, 106, etc. how to configure each of the clusters for the respective projects. In some embodiments, the initial configuration instructions are generated based on the machine learning management policies selected for the projects of the given customer and based on the set of available resources identified as being available for use by the given customer.

At block 308, the project resource scheduler of the machine learning resource management service provides the set of initial configuration instructions to a set of APIs for one or more computing resource services that are providing the set of available resources to the customer, wherein the set of initial configuration instructions allocate respective ones of the resources for use by the respective ones of the projects of the customer. For example, the initial set of configuration instructions may be provided to computing resource services 102, 104, and 106 etc. via APIs 162.

At block 310, the project resource scheduler of the machine learning resource management service monitors usage metrics for the available machine learning resources that have been allocated to the projects of the given customer via the initial set of configuration instructions. For example, telemetry data, usage dashboard data, etc. may be queried or otherwise obtained from computing resource services 102, 104, and 105 etc. and may be provided to the machine learning resource management service 152, in order to understand current utilization rates of the respective resources allocated to the projects managed by the machine learning resource management service.

At block 312, the project resource scheduler of the machine learning resource management service generates updated configuration instructions based on the machine learning management policies selected for the projects of the given customer, the set of available resources identified as being available for use by the given customer, and the usage metrics.

At block 314, the project resource scheduler of the machine learning resource management service automatically provides the updated configuration instructions to the set of APIs for the one or more computing resource services that are providing the set of available resources to the customer, wherein the updated configuration instructions update the allocations of resources for use by the respective ones of the projects of the customer. For example, the updated set of configuration instructions may be provided to computing resource services 102, 104, and 106 etc. via APIs 162.

FIG. 4 illustrates a first example configuration of a machine learning resource management system, wherein customer users (e.g. data scientists) submit machine learning tasks directly to the machine learning resources allocated to the respective projects of the customer, and the machine learning resource management system adjusts the resource allocations to the respective projects to allow under-utilized resources to be used by other projects of the customer, according to some embodiments.

In some embodiments, client devices 120A, such as those of data scientist users of a customer, directly submit training jobs 424 to managed distributed training environments 158A, 158B, and 158C. Also, project resource scheduler 156 provides initial and/or updated configuration instructions 422 via APIs 162 (of computing resource services 102, 104, and 106 etc.) to cause the resources allocated to the customer to be configured into clusters, such as shown in FIG. 4. For example, the resources of distributed training environment 158A are arranged in a cluster 1 that includes lead node 402 and worker nodes 408 and 410. Also, the resources of distributed training environment 158B are arranged in cluster 2 that includes lead node 404 and worker node 412. Additionally, the resources of distributed training environment 158C are arranged in cluster 3 that includes lead node 406 and work nodes 414, 416, 418, and 420. In some embodiments, the respective lead nodes may include a cluster-local scheduler that schedules received jobs and tasks on the respective worker nodes of the cluster. Also, as further described in FIGS. 8A-8B updated configuration instructions 422 may cause worker nodes to be re-assigned between clusters, for example for a limited amount of time to provide “burst capacity.”

Also, client devices 120B (e.g. administrator users of a customer) may define projects and policies via APIs 160.

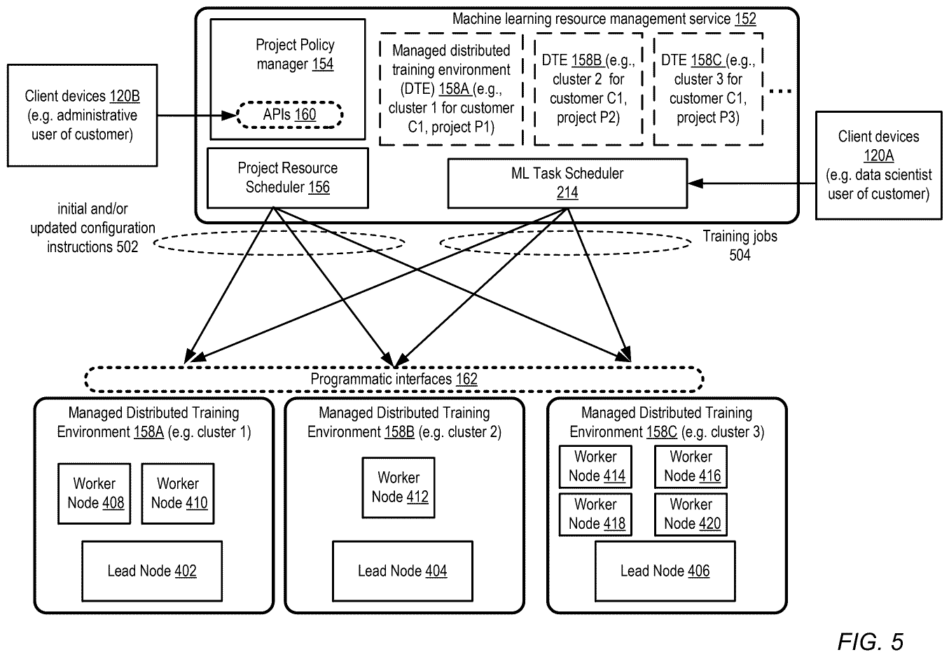

FIG. 5 illustrates a second example configuration of a machine learning resource management system, wherein customer users (e.g. data scientists) submit machine learning tasks for projects of the customer to a machine learning resource management system, and the machine learning resource management system forwards the tasks on to the machine learning resources allocated to the projects that are to perform the tasks, wherein the machine learning resource management system adjusts resource allocations to the projects to allow under-utilized resources to be used by other projects of the customer, according to some embodiments.

In some embodiments, instead of client devices 120A (e.g. data scientist users of the customer) providing training jobs directly to the resources of the distributed training environments, such as lead nodes 402, 404, and 406, the client devices 120A (e.g. data scientist users of the customer) may provide the training jobs 504 to an ML task scheduler 214 of the machine learning resource management service 152. In such embodiments, project resource scheduler 156 may provide initial and/or updated configuration instructions 502 to APIs 160 to configure distributed training environments 158A, 158B, and 158C. Also, the project resource scheduler 156 may update the configurations of the respective clusters. However, in the embodiments shown in FIG. 5, the ML task scheduler may also re-direct at least some jobs to a different cluster in order to take advantage of under-utilized resource capacity. For example, if a given worker node of cluster 3 (which corresponds to project 3) is under-utilized and worker node 412 of cluster 2 (which corresponds to project 2) is fully utilized, then ML task scheduler 214 may re-route at least some jobs or tasks submitted for project 2, to instead be executed using under-utilized capacity of a worker node in cluster 3 (that typically corresponds to project 3). In such embodiments, the respective policies associated with the projects may specify whether jobs or tasks of a given project are eligible to be executed using a resource in a cluster associated with another project. Also, the policies may specify whether under-utilized resources of a cluster associated with a given project are eligible to be used as “burst capacity” to execute a job or task submitted for another project. For example, the project policies may include an option to allow sharing of resources across the security boundaries of the respective clusters associated with each project. Though, some policies may not provide such authorization, in which case these projects would not participate in resource sharing via ML task scheduler 214.

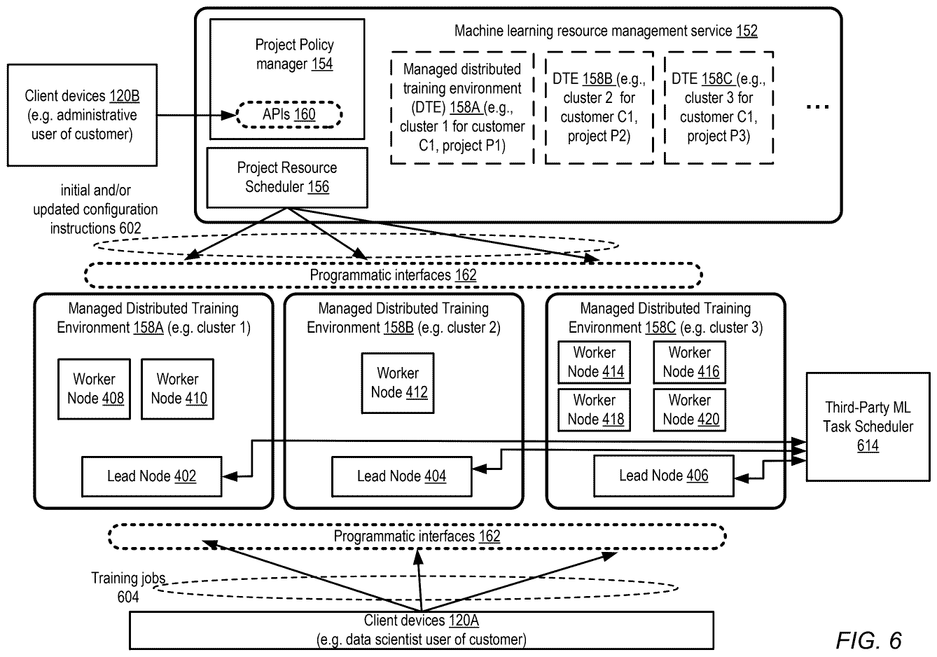

FIG. 6 illustrates a third example configuration of a machine learning resource management system, wherein customer users (e.g. data scientists) submit machine learning tasks directly to the machine learning resources allocated to the respective projects of the customer, the machine learning resources coordinate with a third-party machine learning task scheduler to schedule execution of the tasks using resources allocated to the projects of the customer, and the machine learning resource management system adjusts the resource allocations for the respective projects to allow under-utilized resources to be used by other projects of the customer, according to some embodiments.

In some embodiments, instead of having ML task scheduler 214 included in machine learning resource management service 152, a third party global scheduler, such as third-party ML task scheduler 614 may be used. In such cases, client devices 120A may submit jobs and tasks (e.g. training jobs 604) to lead nodes 402, 404, and 406, but at least some of the jobs or tasks may be re-routed via third party ML task scheduler 614, for example to take advantage of under-utilized capacity. In such embodiments, project resource scheduler 156 may provide scheduling prioritization information to the third-party ML task scheduler 614. For example, policy metadata 208 may be provided to third party ML task scheduler 614 from project resource scheduler 156. Also, within a given cluster, a local scheduler/controller implemented in each of the lead nodes 402, 404, and 406 may schedule tasks on the respective worker nodes of the cluster. Additionally, project resource scheduler 156 submits initial and/or updated configuration instructions 602 to APIs 162 of computing resource services 102, 104, and 106 etc. to configure the respective clusters 1-3 for the managed training environments 158A, 158B, and 158C.

FIG. 7 illustrates example projects and associated policies that may be stored in a project policy information store of a policy manager for a machine learning resource management system, according to some embodiments.

For example, project 702 may be defined for data science goal 1 and may include users 1, 2, and 3 as members of project 702. As another example, project 706 may be defined for data science goal 2 and may include users 1, 2, and 4 as members of project 706. Additionally, project 710 may be defined for data science goal 3 and may include users 5, 6, and 7 as members of project 710. Also, each of projects 702, 706, and 710 may have associated policies. For example, administrative users of a customer (e.g. client devices 120B as shown in FIGS. 4-6) may interact with APIs 160 of the project policy manager 154 to define the respective projects and polices.

Example polices that may be associated with the respective projects include policies 704, 708, and 710, as a few examples. For example, policy 704 defines a total GPU usage limit and GPU usage rate limit, e.g., GPU-hour usage limit X and GPU usage rate per interval of time Y. Additionally, policy 704 indicates that the associated project associated with policy 704 (e.g. project 702) has opted into allowing burst usage of resources and has an unlimited burst setting. This may mean that project 702 is authorized to use burst resources without limit, when available, and when usage conditions of project 702's associated cluster are fully utilized such that burst conditions are present. Also, policy 704 includes an indication that project 702 has opted out of participating in fair sharing. In some situations, this may cause project 702 to be prioritized lower for burst capacity than other projects having an equivalent project prioritization, but a negative burst balance (e.g. meaning that the other projects have provided more burst capacity than they have consumed) and have opted into fair sharing. Though in other embodiments, projects that opt out of fair sharing may share a separate burst pool than projects that opt into fair sharing, in which case project 702 would be available to receive burst capacity from other projects with under-utilized resources that have not opted into fair sharing. In such situations, other projects that do opt into fair sharing may share under-utilized resources amongst each other as burst capacity, but may not share this under-utilized capacity with projects that have not opted into fair sharing. For projects that have not opted into fair sharing, under-utilized capacity (e.g., burst capacity) may be provided on a first come first served basis, whereas for projects opting into fair sharing, under-utilized capacity may be provided as burst capacity according to a prioritization determined based on each project's respective balance of provided and consumed burst capacity.

Policy 708 includes GPU-hour usage limit A and GPU usage rate limit per unit of time B (which may be different values than the respective limits X and Y used by policy 704). Additionally, policy 708 indicates that burst is enabled. However, instead of having an unlimited burst setting, policy 708 defines an upper limit on how much burst capacity project 706 (associated with policy 708) may consume as well as a lower limit on how much burst capacity project 706 (associated with policy 708) may provide to other projects. Additionally, policy 708 indicates that project 706 has opted into participating in fair sharing.

As another example, policy 712 includes GPU-hour usage limit X and GPU usage rate limit per unit of time Y, as well as an indication that project 710 is not participating in burst. In such a case under-utilized resources of project 710 may be excluded from use by other projects, and jobs or tasks of project 710 may be excluded from being executed using under-utilized resources of other projects.

FIG. 8A illustrates observability information for resources allocated to projects of a customer being collected by a project resource scheduler of the machine learning resource management service, according to some embodiments.

For example, project resource scheduler 156 receives observability information 802 indicating that worker node 420 is idle. For example, an agent running in each of lead nodes 402, 404, and 406 may provide cluster utilization information (e.g. observability information 802) to project resource scheduler 156. In embodiments, as shown in FIGS. 5 and 6, ML task scheduler 214 and/or third-party ML task scheduler 614 may include agents that report observability information 802 back to project resource scheduler 156.

FIG. 8B illustrates updated configuration instructions being sent to the resource services that provide the resources allocated to the projects of the customer to adjust the resource allocations, wherein a resource initially allocated to a first project of the customer (that is currently under-utilized) is temporarily re-allocated to a second project of the customer to provide burst capacity to the second project for a limited amount of time (or until pre-empted by the first project), according to some embodiments.

In response to determining worker node 420 is idle and determining that cluster 2 is fully utilized, project resource scheduler 156 sends updated configuration instructions to APIs 162 for computing resource services 102, 104, and 106 etc., wherein the updated configuration instructions cause worker node 420 to be transferred to distributed training environment 158B (e.g. cluster 2) for a limited amount of time, or until pre-empted due to an increase in utilization at distributed training environment 158C (e.g. cluster 3).

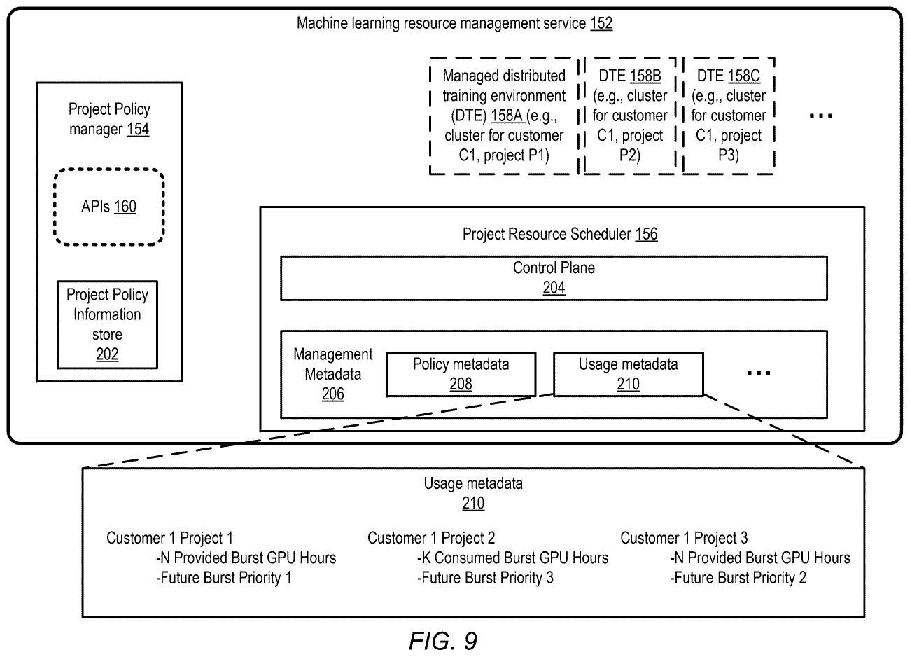

FIG. 9 illustrates examples of usage metadata that may be included in management metadata used by a project resource scheduler to ensure fair share resource allocation and bursting, according to some embodiments.

In some embodiments, in which fair sharing is opted into in the respective policies associated with projects 1, 2, and 3, the usage metadata 210 may include running balances of burst capacity consumed and provided by clusters associated with each of the projects, as well as relative prioritizations for future burst capacity for the projects participating in fair sharing, such as shown in FIG. 9.

FIGS. 10A-10B illustrate a snapshot being taken of a first project that is using burst capacity to speed-up training of a machine learning model, wherein the burst capacity provided to the first project is subsequently pre-empted by a second project, and further wherein an under-utilized resource originally allocated to a third project is then re-allocated to the first project to provide additional burst capacity, wherein the snapshot taken prior to pre-emption of the first burst capacity is provided to the resource provided to enable the additional burst capacity such that the resource provided to enable the additional burst capacity can take advantage of training performed by the first resource provided for the first burst capacity, according to some embodiments.

In some embodiments, snapshots may be taken of worker nodes, and/or clusters during the execution of training jobs. This may allow work performed by burst capacity (e.g. a loaned worker node) to be captured even if only partially completed. Another worker node (either of the same cluster or from burst capacity) may continue to progress the training job from the snapshot, such that the subsequent worker node picks up where the pre-empted work node left off.

For example, at time T1 worker node 420 has been loaned from distributed training environment 158C (cluster 3) to distributed training environment 158B (cluster 2) and is currently performing a training job. While performing the training job, a snapshot 1002 is taken of worker node 420, and the snapshot is stored to remote persistent storage devices 116.

Subsequently, at time T2, utilization of the capacity of the worker nodes in distributed training environment 158C (e.g. cluster 3) increases such that a pre-emption threshold is met. In response, worker node 420 is pre-empted from being used by distributed training environment 158B (e.g., cluster 2) and is returned to distributed training environment 158C (e.g. cluster 3).

Subsequently, at time T3 (shown in FIG. 10B), worker node 410 of distributed training environment 158A (cluster 1) is determined to be idle and is provided to distributed training environment 158B (cluster 2) as replacement burst capacity (e.g. that replaces the prior burst capacity that was pre-empted). Additionally, worker node 410 is loaded with snapshot 1002 such that worker node 410 can continue the training job that worker node 420 only partially completed prior to being pre-empted.

For example, at time T4, worker node 410 resumes work on the partially completed training job starting from a partially complete state captured in snapshot 1002.

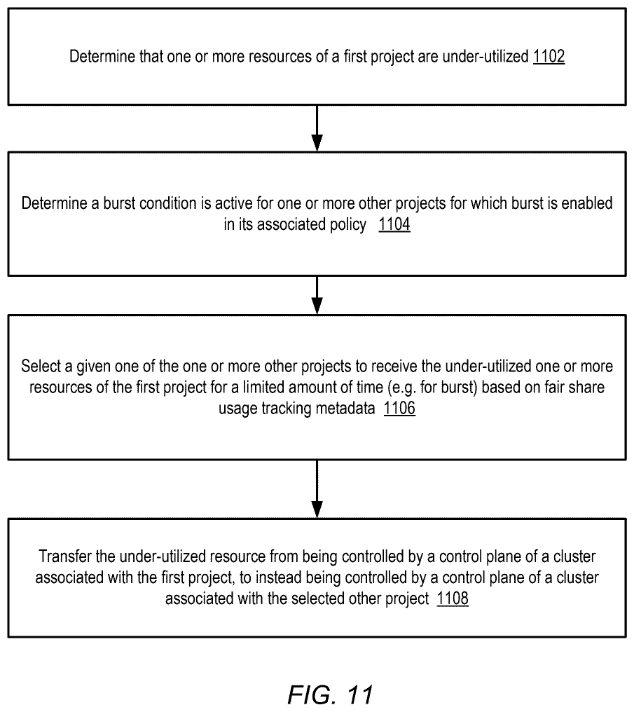

FIG. 11 is a flow diagram illustrating a process of sharing resources across projects to enable burst capacity for a given project, according to some embodiments.

At block 1102, a machine learning resource management system/service determines that one or more resources of a given project managed by the machine learning resource management for a customer are under-utilized. For example, project resource scheduler 156 of machine learning resource management service 152 may identify under-utilized resources using observability information 802 received from computing resource services 102, 104, and 106, etc.

At block 1104, the machine learning resource management system/service determines that there is a burst condition active (e.g. burst threshold met) for at least one other project of the customer that is managed by the machine learning resource management system/service, wherein the at least one other project has an associated policy that enables burst participation.

At block 1106, the machine learning resource management system/service selects a given one of the other projects to receive the under-utilized one or more resources of the first project for a limited amount of time (e.g. for burst) based on fair share usage tracking metadata. For example, the project resource scheduler 156 of machine learning resource management service 152 may utilize usage metadata 210 (such as shown in FIG. 9) to select a given project to receive the burst capacity based on fair share prioritization.

At block 1108, the machine learning resource management system/service transfers the under-utilized resource from being controlled by a control plane of a cluster associated with the first project, to instead being controlled by a control plane of a cluster associated with the selected other project. For example, an under-utilized resource may be transferred between clusters associated with projects, such as shown in FIGS. 8A-8B.

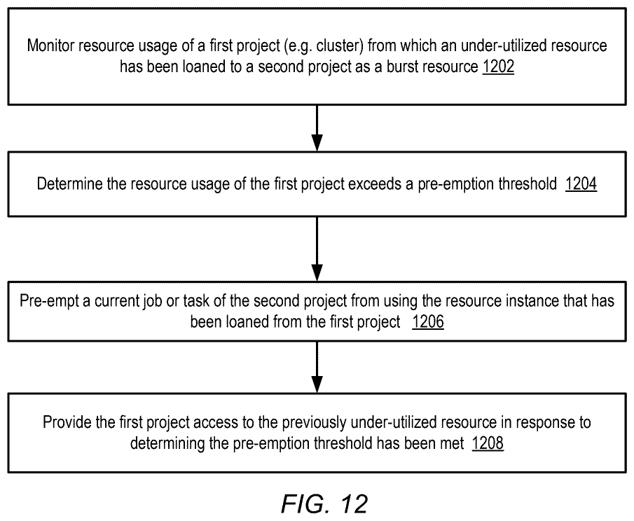

FIG. 12 is a flow diagram illustrating a process of pre-empting, by a first project, access to a resource temporarily loaned from the first project to a second project, in response to a resource utilization level of the first project exceeding a threshold amount, according to some embodiments.

At block 1202, a machine learning resource management system/service monitors resource usage of a first project (e.g. cluster) from which an under-utilized resource has been loaned to a second project as a burst resource. For example, project resource scheduler 156 of machine learning resource management service 152 may monitor resource usage of a first project (e.g. cluster) from which an under-utilized resource has been loaned to a second project as a burst resource using observability information 802 received from computing resource services 102, 104, and 106, etc.

At block 1204, the machine learning resource management system/service determines whether the resource usage of the first project exceeds a pre-emption threshold, and if so, at block 1206 pre-empts a current job or task of the second project from using the resource instance that has been loaned from the first project. Then at block 1208, the machine learning resource management system/service provides the first project access to the previously under-utilized resource in response to determining the pre-emption threshold has been met. For example, an example of pre-emption is shown in FIGS. 10A-10B.

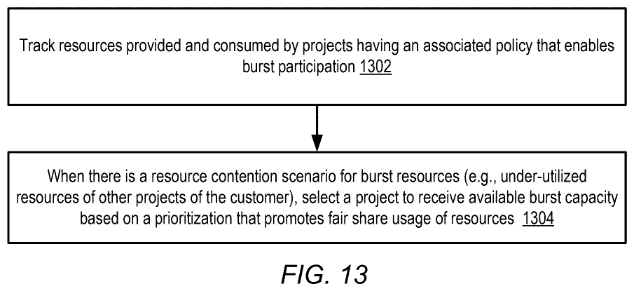

FIG. 13 is a flow diagram illustrating allocating burst capacity based on a fair share resource sharing scheme, according to some embodiments.

At block 1302, a machine learning resource management system/service tracks resources provided and consumed by projects having an associated policy that enables burst participation, for example using observability information 802. Then, at block 1304, in response to determining there is a resource contention scenario for burst resources (e.g., under-utilized resources of other projects of the customer), the machine learning resource management system/service selects a project to receive available burst capacity based on a prioritization that promotes fair share usage of resources. For example, a prioritization as shown in FIG. 9 may be used.

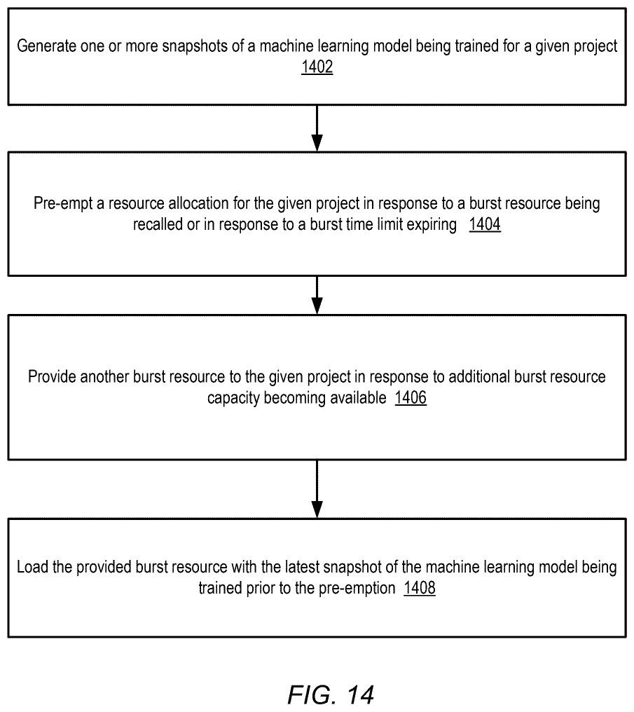

FIG. 14 is a flow diagram illustrating an example process of snapshotting projects using burst capacity and using the snapshots to subsequently provided resources to reduce loss of learning due to pre-emption, according to some embodiments.

At block 1402, one or more snapshots are generated for a machine learning model being trained for a given project. For example, snapshots may be generated as shown in FIGS. 10A-10B.

At block 1404, a machine learning resource management system/service pre-empts a resource allocation for the given project in response to a burst resource being recalled or in response to a burst time limit expiring.

Subsequently, at block 1406, the machine learning resource management system/service provides another burst resource to the given project in response to additional burst resource capacity becoming available. Or alternatively, another job or task executing on a resource already allocated to the given project completes and therefore frees up existing capacity.

At block 1408, the provided burst resource (or newly freed-up existing resource) is loaded with the latest snapshot of the machine learning model being trained prior to the pre-emption. This allows the training to continue from where it left off when the early pre-emption took place.

FIG. 15 illustrates an example provider network at which a machine learning service may be implemented, according to at least some embodiments.

In at least some embodiments, a machine learning resource management service, such as machine learning resource management service 152, may be implemented at a provider network or cloud computing environment. FIG. 15 illustrates an example provider network. In the depicted embodiment, provider network 1501 may comprise resources used to implement a plurality of network-accessible services, including for example a virtualized computing service (VCS) 1503, a database/storage service 1523, a parallel processing service 1571, as well as a machine learning service (MLS) 1533. The machine learning service 1522 may include distributed training coordinators 1520, model execution coordinators 1522, hierarchical checkpointing parameters selection engine 1524, and a client-specific requirements repository 1529. For example, machine learning service 1533 may implement the distributed training environments 158A, 158B, and 158C using resources of computing resources services of the service provider network.

The DTEs used for training large models on behalf of clients of the MLS may, for example comprise servers 1505 (e.g., 1505A, 1505B, 1505C or 1505D) of the virtualized computing service 1503 in the depicted embodiment. The checkpoints which are sent to remote persistent storage, as well as input data or outputs produced by some ML models, may be stored using storage servers of database/storage service 1523, such as SS 1525A, 1525B, 1525C or 1525D. In some cases, distributed training or distributed data pre-processing tasks for some ML models may be performed using server clusters 1549 of the parallel processing service 1571, with the execution of the parallel tasks being orchestrated with the help of cluster managers 1550 in the depicted embodiment. Components of a given service of a provider network may thus in general utilize components of other services in the depicted embodiment. Individual ones of the services shown in FIG. 15 may implement a respective set of programmatic interfaces 1577 which can be used by external and/or internal clients (where the internal clients may comprise components of other services) in the depicted embodiment. In at least some embodiments, resources of a cloud provider network may not be required for the kinds of techniques introduced above; instead, for example, a standalone set of resources may be used.

A cloud provider network can be formed as a number of regions, where a region is a separate geographical area in which the cloud provider clusters data centers. Such a region may also be referred to as a provider network-defined region, as its boundaries may not necessarily coincide with those of countries, states, etc. Each region can include two or more availability zones connected to one another via a private high speed network, for example a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Customers can connect to availability zones of the cloud provider network via a publicly accessible network (e.g., the Internet, a cellular communication network) by way of a transit center (TC). TCs can be considered as the primary backbone locations linking customers to the cloud provider network, and may be collocated at other network provider facilities (e.g., Internet service providers, telecommunications providers) and securely connected (e.g. via a VPN or direct connection) to the availability zones. Each region can operate two or more TCs for redundancy. Regions are connected to a global network connecting each region to at least one other region. The cloud provider network may deliver content from points of presence outside of, but networked with, these regions by way of edge locations and regional edge cache servers (points of presence, or PoPs). This compartmentalization and geographic distribution of computing hardware enables the cloud provider network to provide low-latency resource access to customers on a global scale with a high degree of fault tolerance and stability.

In some embodiments, an MLS may be implemented at least in part using an edge location of the provider network instead of or in addition to regional data centers. An edge location (or “edge zone”), as referred to herein, can be structured in several ways. In some implementations, an edge location can be an extension of the cloud provider network substrate including a limited quantity of capacity provided outside of an availability zone (e.g., in a small data center or other facility of the cloud provider that is located close to a customer workload and that may be distant from any availability zones). Such edge locations may be referred to as provider network extension sites or local zones (due to being more local or proximate to a group of users than traditional availability zones). A local zone may be connected in various ways to a publicly accessible network such as the Internet, for example directly, via another network, or via a private connection to a region. In some implementations, an edge location may be an extension of the cloud provider network substrate formed by one or more servers located on-premise in a customer or partner facility, wherein such server(s) communicate over a network (e.g., a publicly-accessible network such as the Internet) with a nearby availability zone or region of the cloud provider network. This type of substrate extension located outside of cloud provider network data centers can be referred to as an “outpost” of the cloud provider network.

A VCS of the cloud provider network may offer virtual compute instances (also referred to as virtual machines, or simply “instances”) with varying computational and/or memory resources in various embodiments, which may be used to implement components of an MLS or to perform distributed training of ML models. In one embodiment, each of the virtual compute instances may correspond to one of several instance types, families or categories, and instances of any of several families may be employed for computations of the MLS. An instance type may be characterized by its hardware type, computational resources (e.g., number, type, and configuration of central processing units (CPUs) or CPU cores, GPUs, or hardware accelerators for various tasks, including HTAs), memory resources (e.g., capacity, type, and configuration of local memory), storage resources (e.g., capacity, type, and configuration of locally accessible storage), network resources (e.g., characteristics of its network interface and/or network capabilities), and/or other suitable descriptive characteristics (such as being a “burstable” instance type that has a baseline performance guarantee and the ability to periodically burst above that baseline, a non-burstable or dedicated instance type that is allotted and guaranteed a fixed quantity of resources, or an instance type optimized for radio-based applications). Each instance type can have a specific ratio of processing, local storage, memory, and networking resources, and different instance families may have differing types of these resources as well. Multiple sizes of these resource configurations can be available within a given instance type. Using instance type selection functionality, an instance type may be selected for a customer, e.g., based (at least in part) on input from the customer. For example, a customer may choose an instance type from a predefined set of instance types. As another example, a customer may specify the desired resources of an instance type and/or requirements of a workload that the instance will run, and the instance type selection functionality may select an instance type based on such a specification. A suitable host for the requested instance type can be selected based at least partly on factors such as collected network performance metrics, resource utilization levels at different available hosts, and so on.

The traffic and operations of the cloud provider network, and individual services such as the MLS, may broadly be subdivided into two categories in various embodiments: control plane operations and data plane operations. While the data plane represents the movement of data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, or system state information management). The data plane includes customer resources that are implemented on the cloud provider network (e.g., computing instances, containers, block storage volumes, databases, or file storage). Data plane traffic generally includes non-administrative operations such as transferring customer data to and from the customer resources. Certain control plane components (e.g., tier one control plane components such as the control plane for a virtualized computing service) are typically implemented on a separate set of servers from the data plane servers, while other control plane components (e.g., tier two control plane components such as analytics services) may share the virtualized servers with the data plane, and control plane traffic and data plane traffic may be sent over separate/distinct networks.

In at least some embodiments, a server that implements the types of techniques described herein (e.g., various functions of an MLS and/or other services of a provider network), may include a general-purpose computer system that includes or is configured to access one or more computer-accessible media. FIG. 16 illustrates such a general-purpose computing device 1600. In the illustrated embodiment, computing device 1600 includes one or more processors 1610 coupled to a system memory 1620 (which may comprise both non-volatile and volatile memory modules) via an input/output (I/O) interface 1630. Computing device 1600 further includes a network interface 1640 coupled to I/O interface 1630.

In various embodiments, computing device 1600 may be a uniprocessor system including one processor 1610, or a multiprocessor system including several processors 1610 (e.g., two, four, eight, or another suitable number). Processors 1610 may be any suitable processors capable of executing instructions. For example, in various embodiments, processors 1610 may be general-purpose or embedded processors implementing any of a variety of instruction set architectures (ISAs), such as the x86, PowerPC, SPARC, ARM, or MIPS ISAs, or any other suitable ISA. In multiprocessor systems, each of processors 1610 may commonly, but not necessarily, implement the same ISA. In some implementations, graphics processing units (GPUs) and or field-programmable gate arrays (FPGAs) may be used instead of, or in addition to, conventional processors.

System memory 1620 may be configured to store instructions and data accessible by processor(s) 1610. In at least some embodiments, the system memory 1620 may comprise both volatile and non-volatile portions; in other embodiments, only volatile memory may be used. In various embodiments, the volatile portion of system memory 1620 may be implemented using any suitable memory technology, such as static random access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 1620 as code 1625 and data 1626.

In one embodiment, I/O interface 1630 may be configured to coordinate I/O traffic between processor 1610, system memory 1620, and any peripheral devices in the device, including network interface 1640 or other peripheral interfaces such as various types of persistent and/or volatile storage devices. In some embodiments, I/O interface 1630 may perform any necessary protocol, timing or other data transformations to convert data signals from one component (e.g., system memory 1620) into a format suitable for use by another component (e.g., processor 1610). In some embodiments, I/O interface 1630 may include support for devices attached through various types of peripheral buses, such as a variant of the Peripheral Component Interconnect (PCI) bus standard or the Universal Serial Bus (USB) standard, for example. In some embodiments, the function of I/O interface 1630 may be split into two or more separate components, such as a north bridge and a south bridge, for example. Also, in some embodiments some or all of the functionality of I/O interface 1630, such as an interface to system memory 1620, may be incorporated directly into processor 1610.

Network interface 1640 may be configured to allow data to be exchanged between computing device 1600 and other devices 1660 attached to a network or networks 1650, such as other computer systems or devices as illustrated in FIG. 1 through FIG. 15, for example. In various embodiments, network interface 1640 may support communication via any suitable wired or wireless general data networks, such as types of Ethernet network, for example. Additionally, network interface 1640 may support communication via telecommunications/telephony networks such as analog voice networks or digital fiber communications networks, via storage area networks such as Fibre Channel SANs, or via any other suitable type of network and/or protocol.

In some embodiments, system memory 1620 may represent one embodiment of a computer-accessible medium configured to store at least a subset of program instructions and data used for implementing the methods and apparatus discussed in the context of FIG. 1 through FIG. 15. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 1600 via I/O interface 1630. A non-transitory computer-accessible storage medium may also include any volatile or non-volatile media such as RAM (e.g. SDRAM, DDR SDRAM, RDRAM, SRAM, etc.), ROM, etc., that may be included in some embodiments of computing device 1600 as system memory 1620 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 1640. Portions or all of multiple computing devices such as that illustrated in FIG. 16 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

### Conclusion

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A system for implementing a machine learning resource management service, the system comprising:
one or more computing devices configured to implement a policy manager configured to:
provide one or more application programmatic interfaces (APIs) for use by a customer of the machine learning resource management service, wherein the one or more APIs are configured to:
receive a customer input defining a plurality of projects of the customer; and
determine, based on the customer input, one or more machine learning resource management policies to be associated with respective ones of the projects of the customer; and
one or more computing devices configured to implement a resource scheduler configured to:
identify a set of machine learning resources available to be assigned to the projects of the customer, wherein the machine learning resources comprise virtualized computing resources with access to graphics processing units (GPUs);
provide, to a set of application programmatic interfaces (APIs) of one or more computing resource services providing the set of machine learning resources to the customer, a set of initial configuration instructions that allocate the available machine learning resources to the projects of the customer based on the one or more machine learning resource management policies associated with the respective ones of the projects of the customer;
monitor usage metrics of the available machine learning resources by the respective projects of the customer; and
automatically provide, to the set of APIs, updated configuration instructions based on the one or more machine learning resource management policies associated with the respective ones of the projects of the customer and based on the monitored usage metrics.

2. The system of claim 1, wherein:
the available machine learning resources are organized into clusters;
each of the projects is associated with a corresponding cluster of machine learning resources; and
the initial configuration instructions and the updated configuration instructions, when provided to the set of APIs, cause the available machine learning resources to be allocated to the respective clusters corresponding to the respective projects based on the respective one or more machine learning resource management polices associated with the projects and based on the usage metrics.

3. The system of claim 1, wherein the one or more machine learning resource management policies comprise one or more of:
a GPU-hour resource usage limit for a given project; or
a limit for GPU usage rate by a given project for a given time interval.

4. The system of claim 3, wherein the one or more machine learning resource management policies further comprise:
a burst policy,
wherein, for projects having the burst policy, the resource scheduler is further configured to:
cause, via the updated configuration instructions, an under-utilized machine learning resource allocated to a first project to be used by a second project.

5. The system of claim 4, wherein the resource scheduler is further configured to:
track respective amounts of burst capacity provided, or used by, the respective projects; and
assign priorities for access to future burst capacity to the respective projects based on previously provided or consumed amounts of burst capacity.

6. A method, comprising:
providing one or more application programmatic interfaces (APIs) for use by a customer of a resource management service, wherein the one or more APIs are configured to:
receive a customer input defining a plurality of projects of the customer; and
determine, based on the customer input, one or more resource management policies to be associated with respective ones of the projects of the customer;
identifying, by one or more computing devices implementing a resource scheduler, a set of resources available to be assigned to the projects of the customer;
providing, by the resource scheduler, to a set of application programmatic interfaces (APIs) of one or more computing resource services providing the set of resources to the customer, a set of initial configuration instructions that allocate the available resources to the projects of the customer based on the one or more resource management policies associated with the respective ones of the projects of the customer;
monitoring, by the resource scheduler, usage metrics of the available resources by the respective projects of the customer; and
automatically providing, by the resource scheduler, to the set of APIs, updated configuration instructions based on the resource management policies associated with the respective ones of the projects of the customer and based on the monitored usage metrics.

7. The method of claim 6, wherein the one or more resource management policies comprise one or more of:
a graphics processing unit (GPU)-hour resource usage limit for a given project; or
a limit for GPU usage rate by a given project for a given time interval.

8. The method of claim 6, wherein the one or more resource management policies comprise:
a burst policy, wherein, for projects having the burst policy, the method further comprises:
causing, by the resource scheduler, via the updated configuration instructions, an under-utilized resource allocated to a first project to be used by a second project.

9. The method of claim 8, comprising:
in response to detecting a burst condition for the second project:
disassociating a given virtualized computing resource from a first resource cluster associated with the first project; and
associating the given virtualized computing resource with a second resource cluster associated with the second project, wherein a management plane of the second resource cluster controls virtualized computing resources already associated with the second cluster and the given virtualized computing resource that has been transferred to the second resource cluster in response to the burst condition being detected.

10. The method of clam 8, further comprising:
tracking respective amounts of burst capacity provided, or used by, the respective projects; and
assigning priorities for access to future burst capacity to the respective projects based on previously provided, or consumed, amounts of burst capacity.

11. The method of claim 8, further comprising:
generating one or more snapshots of a machine learning model being trained for the second project;
in response to determining that a resource utilization of the first project meets a threshold for burst pre-emption, causing the previously under-utilized resource to no longer be available for use by the second project and causing the previously under-utilized resource to be returned to being available for use by the first project; and
causing, via another set updated configuration instructions, an additional under-utilized resource allocated to the first project or another project to be used by the second project to provide burst capacity,
wherein the second project provides a latest snapshot generated prior to the pre-emption to the additional under-utilized resource to continue the training of the machine learning model from a partially completed state captured in the latest snapshot.

12. The method of claim 6, further comprising:
receiving, via the one or more APIs provided for use by the customer of the resource management service, one or more policy changes with regard to one or more policies associated with one or more of the projects of the customer; and
automatically, providing, by the resource scheduler, to the set of APIs, additional updated configuration instructions based on the one or more policy changes.

13. The method of claim 6, wherein:
the monitored usage metrics indicate under-utilization of allocated resources by a first project; and
the updated configuration instructions comprise instructions to reduce an allocation of resources to the first project, wherein the reduced allocation enables resources of the customer previously allocated to the first project to be used by another project of the customer in response to burst conditions being met at the other project of the customer.

14. The method of claim 6, wherein:
the resources available to be assigned to the projects of the customer comprise different types of resources provided by different resource services of a service provider network; and
the set of APIs to which the set of initial configuration instructions and the updated configuration instructions are provided include different APIs of different services of the service provider network.

15. One or more non-transitory, computer-readable, storage media, storing program instructions that, when executed using one or more processors, cause the one or more processors to:
provide one or more application programmatic interfaces (APIs) for use by a customer of a resource management service, wherein the one or more APIs are configured to:
receive a customer input defining a plurality of projects of the customer; and
determine, based on the customer input, one or more resource management policies to be associated with respective ones of the projects of the customer;
identify a set of resources available to be assigned to the projects of the customer;
provide, to a set of application programmatic interfaces (APIs) of one or more computing resource services providing the set of resources, a set of initial configuration instructions that allocate the available resources of the customer to the projects of the customer based on the one or more resource management policies associated with the respective ones of the projects of the customer;
monitor usage metrics of the available resources by the respective projects of the customer; and
automatically provide, to the set of APIs, updated configuration instructions based on the resource management policies associated with the respective ones of the projects of the customer and based on the monitored usage metrics.

16. The one or more non-transitory, computer-readable, storage media of claim 15, wherein the one or more resource management policies comprise one or more of:
a graphics processing unit (GPU)-hour resource usage limit for a given project; or
a limit for GPU usage rate by a given project for a given time interval.

17. The one or more non-transitory, computer-readable storage media of claim 15, wherein:
the set of resources available to be assigned to the projects of the customer comprise different types of resources provided by different resource services of a service provider network; and
the set of APIs to which the set of initial configuration instructions and the updated configuration instructions are provided include different APIs of different services of the service provider network.

18. The one or more non-transitory, computer-readable storage media of claim 15, wherein:
project users of the projects submit machine learning tasks for execution to the resources of the one or more computing resource services; and
a resource scheduler, implemented via the program instructions, performs said monitoring of the usage metrics via communications between the resource scheduler and local schedulers of the one or more computing resource services.

19. The one or more non-transitory, computer-readable storage media of claim 15, wherein:
project users of the projects submit machine learning tasks for execution to a resource scheduler implemented via the program instructions; and
the resource scheduler implemented via the program instructions performs said monitoring of the usage metrics based on tasks submitted by the project users.

20. The one or more non-transitory, computer-readable storage media of claim 15, wherein:
project users of the projects submit machine learning tasks for execution to the resources of the one or more computing resource services;
a third-party resource scheduler provides the updated configuration instructions to a resource scheduler implemented via the program instructions; and
the resource scheduler implemented via the program instructions performs said automatically providing the updated configuration instructions to the set of APIs for the one or more computing resource services.
